(19) United States
(12) Patent Application Publication
(10) Pub. No.: US 2015/0314667 A1
(43) Pub. Date: Nov. 5, 2015

(54) HEAT EXCHANGER FOR AN INTERNAL COMBUSTION ENGINE

(71) Applicant: PIERBURG GMBH, Neuss (DE)

(72) Inventors: HANS-JUERGEN HUESGES, WILLICH (DE); HANS-ULRICH KUEHNEL, MOENCHENGLADBACH (DE); PETER CORBACH, BOCHUM (DE)

(21) Appl. No.: 14/649,919

(22) PCT Filed: Nov. 12, 2013
(86) PCT No.: PCT/EP2013/073623

§ 371 Date: Jun. 5, 2015

(30) Foreign Application Priority Data
Dec. 7, 2012 (DE) 10 2012 111 928.7

(51) Int. Cl. B60H 1/32

(52) U.S. Cl. CPC B60H 1/32

(57) ABSTRACT

A heat exchanger for an internal combustion engine includes a channel configured to have a fluid to be cooled flow therethrough, a coolant channel, and a separating wall configured to separate the coolant channel from the channel. The separating wall comprises knobs on a surface facing the coolant channel. The knobs are arranged on the surface so as to form first zones comprising the knobs and second zones comprising a smooth surface without the knobs. The first zones and the second zones are arranged relative to each another so as to from zones with a different flow resistance.

### CROSS REFERENCE TO PRIOR APPLICATIONS

This application is a U.S. National Phase application under 35 U.S.C. §371 of International Application No. PCT/EP2013/073623, filed on Nov. 12, 2013 and which claims benefit to German Patent Application No. 10 2012 111 928.7, filed on Dec. 7, 2012. The International Application was published in German on Jun. 12, 2014 as WO 2014/086558 A1 under PCT Article 21(2).

### FIELD

The present invention relates to a heat exchanger for an internal combustion engine comprising a channel through which a fluid to be cooled can flow, a coolant channel, a separating wall separating the coolant channel from the channel through which a fluid to be cooled can flow, wherein knobs are formed on a surface of the separating wall directed to the coolant channel.

### BACKGROUND

Heat exchangers are produced in a great variety of forms. They may be designed as plate heat exchangers, tube bundle heat exchangers, or also as die cast heat exchangers with two nested housings.

In particular with heat exchangers used in the automobile industry, which are used to cool exhaust gas or to cool charge air, a constant demand exists for higher cooling capacities and, if possible, reduced structural size of the heat exchangers. Various proposals have been made to address this demand via which the coolant is guided closer to the exhaust gas flow, or the surface area available for heat exchange was increased on the gas side. Means have further become known which allow the coolant flow to be guided so as to ensure that the coolant flows around the entire inner housing.

EP 2 333 473 A2 describes a heat exchanger formed by an outer housing and an inner housing between which a coolant channel is formed. Ribs extend into the gas-carrying channel in order to enlarge the heat exchange surface. Recesses are also formed in the separation wall between the gas channel and the coolant channel, each recess being formed at the level of the ribs to extend in a manner corresponding to the ribs, the recesses being provided to guide the coolant flow closer to the gas flow so as to achieve a higher efficiency.

EP 2 413 080 A2 describes form webs in the coolant jacket which achieve a meander-like flow around the inner housing. Dead water zones are thereby avoided, whereby cooling capacity also increases.

EP 2 284 471 A2 describes forming individual webs in the coolant channel so that a flow around the inner housing is achieved that is as uniform as possible while minimizing the number of webs. Mathematical models are developed for this purpose which calculate the natural flow path without webs, and thereafter, the webs are positioned so that a flow around the full circumference is achieved, while the pressure loss is as low as possible.

A plate heat exchanger is described in EP 0 815 971 A1 whose plate surfaces have knobs and separating walls extending into the coolant channels. The knobs are intended to enlarge the heat exchange surface, whereas the separating walls ensure an accurate guiding of the coolant.

A common feature of all these designs is that the existing structural features either increase the heat exchange or realize a guiding of the coolant flow so that, in all known designs, a sufficient cooling capacity is not achieved relative to the structural space required.

### SUMMARY

An aspect of the present invention is to provide a heat exchanger for an internal combustion engine with a geometry that can be realized as simply as possible, whereby the achievable cooling capacities are further increased compared to known designs.

In an embodiment, the present invention provides a heat exchanger for an internal combustion engine which includes a channel configured to have a fluid to be cooled flow therethrough, a coolant channel, and a separating wall configured to separate the coolant channel from the channel. The separating wall comprises knobs on a surface facing the coolant channel. The knobs are arranged on the surface so as to form first zones comprising the knobs and second zones comprising a smooth surface without the knobs. The first zones and the second zones are arranged relative to each another so as to from zones with a different flow resistance.

### BRIEF DESCRIPTION OF THE DRAWINGS

The present invention is described in greater detail below on the basis of embodiments and of the drawings in which:

FIG. 1 shows a three-dimensional view of a heat transfer device of the present invention, seen obliquely from above;

FIG. 2 shows a sectional front end view of the heat transfer device of the present invention illustrated in FIG. 1;

FIG. 3 shows a three-dimensional view of a detail of a separating wall surface of a heat exchanger according to the present invention; and

FIG. 4 shows a schematic top plan view on a separating wall of a heat exchanger of the present invention.

### DETAILED DESCRIPTION

Because the separating wall in the coolant channel is formed with a plurality of zones having knobs and with a plurality of zones having a smooth surface, wherein the two zones are arranged with respect to each other so that zones with different flow resistances are formed, a guiding of the coolant is realized, whereby the cooling capacity can be increased significantly at the separating wall by enlarging the existing heat exchange surface and the achievable uniform flow without dead water zones.

In an embodiment of the present invention, the zones in which knobs are formed can, for example, be larger than the zones having a smooth surface. Since the smooth-surface zones merely effect a distribution of the flow, for which purpose small cross sections are sufficient, whereas the increase in efficiency is achieved by the zones having the knobs, the results achieved with such a design are particularly good.

The knobs can advantageously protrude to just before a housing wall that delimits the coolant channel on the side opposite the separating wall. This means that the knobs end a small distance from the opposite wall so that coolant still flows all around the knobs. The entire surface is thus available for heat exchange and a particularly large part of the coolant flow actually contacts the surface in these zones.

Particularly large surfaces, which at the same time have low flow resistances, are achieved if the knobs are of a spherical section shape or a pyramid shape. These structures are also easy to manufacture and allow for an increase in the available heat exchange surface by up to 45%.

In an embodiment of the present invention, the heat exchanger can, for example, have an inner housing in which the channel is arranged through which the fluid to be cooled can flow, and an outer housing which surrounds the coolant channel, wherein the side walls of the inner housing serve as the separating wall. Such a heat exchanger can be manufactured at low cost in a die casting process, for example, in which the knob structures can be integrated into the molds in a simple manner. The assembly is further particularly simple, thereby lowering assembly costs.

The outer housing is provided with a coolant inlet and a coolant outlet in order to make a particularly simple connection of the coolant lines in the internal combustion engine. No further assembly steps are required.

In an embodiment of the present invention, the zones with the smooth surface and the zones having the knobs are arranged relative to each other downstream of the coolant inlet so that the coolant flow is equally distributed over the separating wall. This can be determined, for example, via flow simulations for the specific design of the heat exchanger. Zones with knobs are thereby typically to be formed in zones in which a low flow resistance and, thus, a high flow velocity, prevail. Particularly high cooling capacities are achieved with a uniform flow distribution.

In an embodiment of the present invention, a smooth-surface zone is arranged downstream of the coolant inlet which extends along the length of the separating wall which, seen in a width direction, is followed by a first zone with knobs that extends along the length of the separating wall. Before flowing over the knob zone in which the flow resistance is higher, the coolant flow is thereby distributed relatively uniformly in the knob-free zone and flows from there towards the coolant outlet.

In a development thereof, the first knob zone is followed by a section that extends over the rest of the width of the separating wall and in which, seen in the longitudinal direction, larger zones with knobs formed therein alternate with narrow zones with a smooth surface. A flow is thereby generated whose main flow direction is along the width of the separating wall since the narrow zones with the smooth surface determine this flow direction due to the lower flow resistance. A uniform flow with a high efficiency and relatively low pressure loss is thereby formed.

A heat exchanger with an increased cooling capacity and a reduced structural space is thus provided. This is achieved by simultaneously providing a guiding of the flow and an increase in the surface by a corresponding arrangement of the knobs.

An embodiment of a heat exchanger according to the present invention is illustrated in the drawings and will be hereinafter be described.

The heat exchanger illustrated in the drawings comprises an outer housing 2, in which a two-part inner housing 4 with an upper shell 6 and a lower shell 8 is arranged. The upper shell 6 and the lower shell 8 are joined by friction stir welding.

Both the upper shell 6 and the lower shell 8 of the inner housing 4, which can each, for example, be manufactured by a die casting process, comprise a respective separating wall 10 from which, seen in cross section, ribs 12 alternately extend from the upper shell 6 and the lower shell 8 into a channel 14 inside the inner housing 4, through which channel 14 a fluid to be cooled can flow. This fluid may be the exhaust gas of an internal combustion engine.

The inner housing 4 is pushed into the outer housing 2 so that a coolant channel 16 is formed between the inner housing 4 and the outer housing 2, through which channel a coolant can flow and which is separated by the separating wall 10 from the channel 14 through which the fluid to be cooled can flow. The inner housing 4 is connected tightly with the outer housing 2 by flange connections 18 so that the coolant channel is designed as a closed coolant jacket.

The channel 14 through which the fluid to be cooled can flow, extends from an inlet 20 at the front end side of the heat exchanger to an outlet 22 on the opposite side of the heat exchanger. An intermediate wall 24 divides the channel 14 into two sub-channels 26, 28, wherein the first sub-channel 26 is connected with an exhaust manifold of a first set of cylinders, and the second sub-channel 28 is connected with an exhaust manifold of a second set of cylinders of the internal combustion engine. Due to this separation, interferences between the individual emitted exhaust gas pulses are prevented, whereby the total mass flow can be increased if downstream check valves are used.

The intermediate wall 24 extends continuously from the separating wall 10 of the lower shell 8 into an opposite groove 30 formed in the separating wall 10 of the upper shell 6. The intermediate wall 24 is fastened in the opposite groove 30 by friction stir welding through the separating wall 10 so that an overflow of the intermediate wall 24 is prevented and, at the same time, the stability of the inner housing 4 is significantly increased by halving the existing projected areas.

The separating wall 10 both of the lower shell 8 and the upper shell 6 of the inner housing 4 has a wave-shaped outer surface 32. The wave-shaped outer surface 32 is obtained by recesses 34 between rib bases 36 of the successive rows of ribs. In the regions of the wave-shaped outer surface 32, which are situated in the longitudinal direction between the rows of ribs, the recesses 34 merely show an offset extending over this region so that, at the beginning of the next row of ribs, which is offset from the previous row in the same manner, the recesses 34 are again arranged in the gaps between the rib bases 36.

The outer housing 2, which can, for example, be manufactured by a sand casting process, has an inner wall 38 which is designed to correspond to the recesses 34 of the inner housing 4. This means that a projection 40 extends into each recess 34 between two rib bases 36 so that the distance of the wave-shaped outer surface 32 of the inner housing 4 from the inner wall 38 of the outer housing 2 is substantially the same throughout. The flow cross section is therefore substantially the same everywhere both in the flow direction and perpendicular to the flow direction.

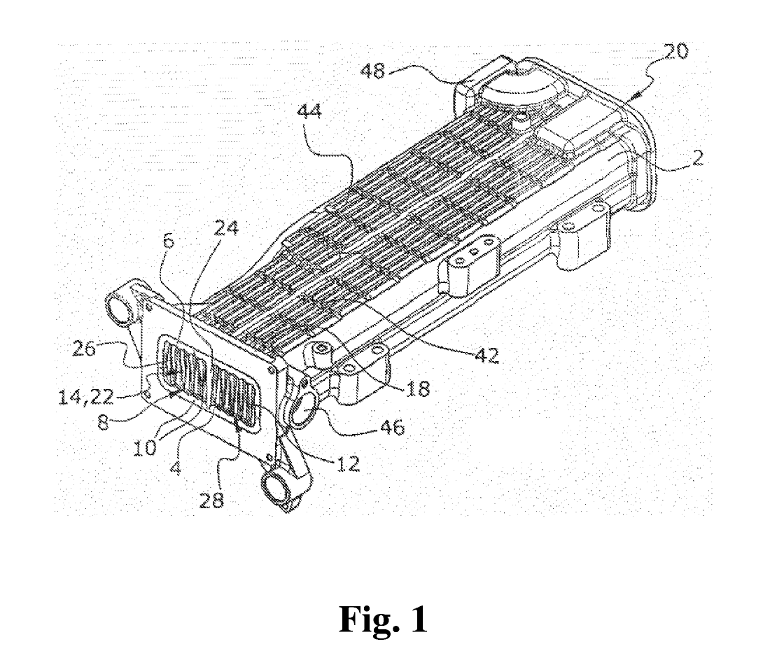

The projections 40 are formed by trough-shaped recesses 42 in an outer wall 44 of the outer housing 2 in order to increase rigidity. On the respective opposite side, i.e., on the inner wall 38, the projection 40 is formed by a displacement of material when such a trough-shaped recess 42 is formed at a later time. This form can also be obtained directly during the casting process, whereby an increase in rigidity is also achieved without increasing the amount of material required. The outer housing 2 is formed with a flange-shaped coolant outlet 48, as is shown in FIG. 1.

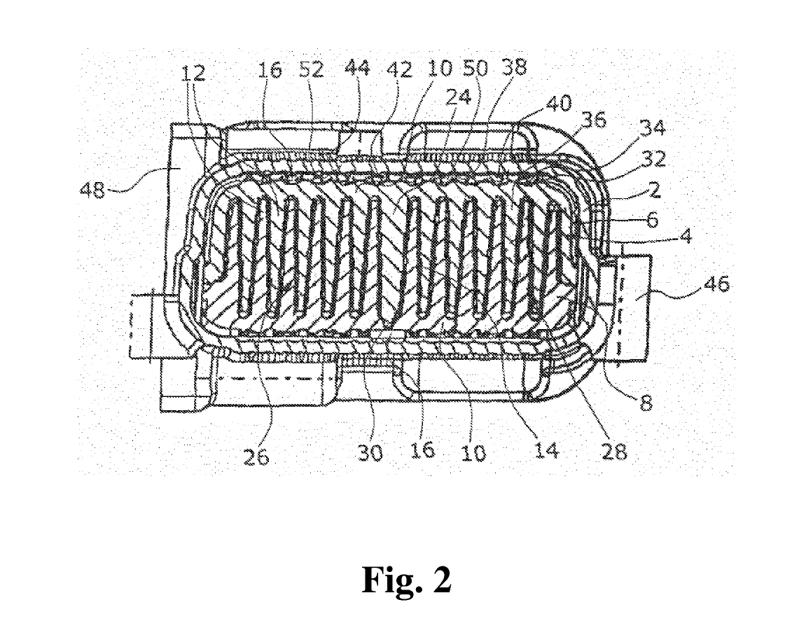

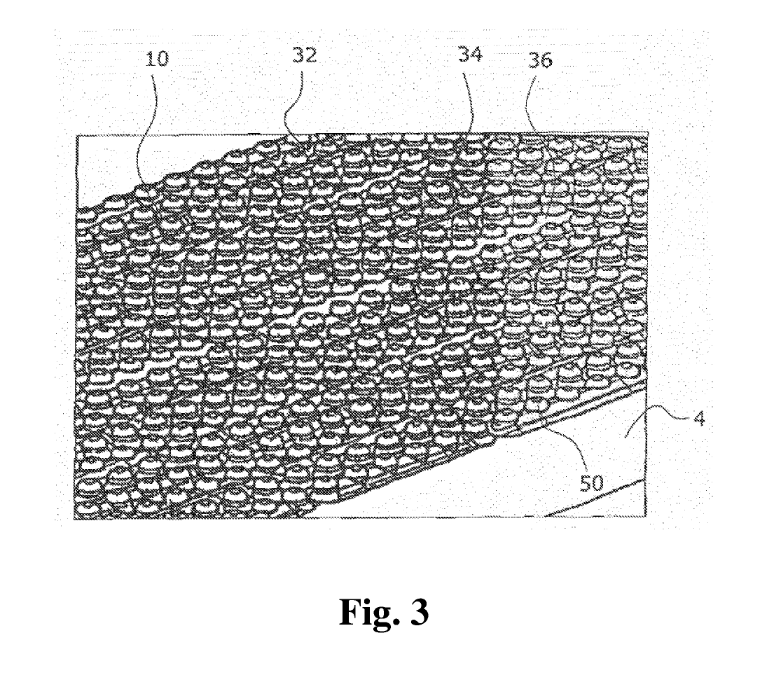

Knobs 50 are formed on the surface of the separating wall 10 of the inner housing 4, which knobs 50 protrude into the coolant channel 16, as is schematically indicated in FIG. 2 and is illustrated in a detail in FIG. 3. The knobs 50 visible in FIG. 3 have a spherical segment-shaped structure, which is easy to obtain in a die casting process, and provide a surface enlargement increasing the surface available for heat exchange by about 45%. The knobs 50 protrude to just before an opposite inner housing wall 52 of the outer housing 2.

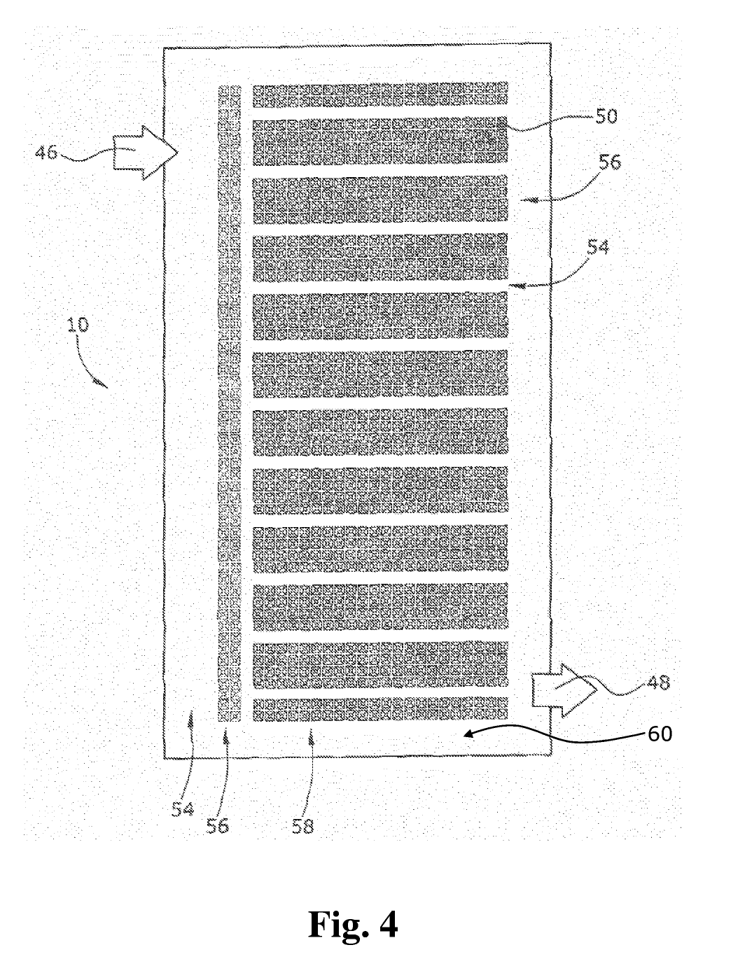

FIG. 4 shows how a guiding of the coolant on the separating wall 10 can be achieved via the arrangement of the knobs 50, which are shown to be pyramid-shaped, without using additional webs. Zones 54 with a smooth surface, i.e., without knobs 50, and zone 56 with a knob structure are formed on the separating wall 10 for this purpose.

In order to realize this guiding of coolant, a zone 54 with a smooth surface is first formed downstream of a coolant inlet 46. Smooth-surface zone 54 also extends along the entire length of the separating wall 10 or the inner housing 4, respectively. Seen in the width direction of the separating wall 10, zone 56 follows which, seen along the entire length, is provided with knobs 50. This region therefore offers a higher flow resistance and the coolant is first distributed along the length of the separating wall 10 in the smooth-surface zone 54 due to the lower flow resistance there. Again seen in the width direction, a section 58 follows in which, seen along the length direction, knob zones 56 and smooth-surface zones 54 alternate, where, however, the width of the smooth surface zones 54 only correspond to about one quarter of the knob zones 56. This structure extends linearly along the remaining width of the separating wall 10. In the smooth-surface zones 54, a flow filament is formed which, due to the lower flow resistance, generates a main flow direction along the width of the separating wall 10. Owing to these flow filaments, in which a higher flow velocity prevails than in the knob zones 56, a pressure gradient is generated in the knob zones 56, whereby a main flow in the width direction is also generated in these regions. It follows from the aforementioned that the entire separating wall 10 is flown through substantially uniformly across its width, while a flow in a transverse direction, i.e., towards the coolant outlet, is also generated, which, however, is significantly impeded by all these structures and is therefore no longer the main flow direction. Another smooth-surface zone 54 is formed in the adjoining section 60 via which the coolant flows to the coolant outlet 48.

It follows from the aforementioned that the present invention makes it possible to optimize the flow direction and the distribution of coolant via a skillful arrangement of a structure with zones having knobs and smaller zones with smooth surfaces, the structure significantly increasing the heat exchanger surface. Depending on the given flow resistances, as well as on the arrangement of the coolant inlet and the coolant outlet and the shape of the heat exchanger housing, this arrangement must be adapted, which is in particular possible with the use of mathematical flow models. A heat exchanger is thereby provided which has a significantly increased cooling capacity, while the structural space remains the same, or which can be reduced in structural space.

It should be evident that the scope of protection of the present invention is not restricted to the embodiment described, but that, compared to the embodiment described, the arrangement of the knobs can be adapted depending on the structure and shape of the heat exchanger and on the arrangement of the inlets and the outlets. Reference should be had to the appended claims.

What is claimed is:

1-9. (canceled)

10. A heat exchanger for an internal combustion engine, the heat exchanger comprising:
a channel configured to have a fluid to be cooled flow therethrough;
a coolant channel; and
a separating wall configured to separate the coolant channel from the channel, the separating wall comprising knobs on a surface facing the coolant channel, the knobs being arranged on the surface so as to form first zones comprising the knobs and second zones comprising a smooth surface without the knobs, the first zones and the second zones being arranged relative to each another so as to from zones with a different flow resistance.

11. The heat exchanger as recited in claim 10, wherein the second zones are larger than the first zones.

12. The heat exchanger as recited in claim 10, further comprising:
a housing wall configured to delimit the coolant channel on an opposite side of the separating wall,
wherein, the knobs are configured to protrude to just before the housing wall.

13. The heat exchanger as recited in claim 10, wherein the knobs are have a spherical segment shape or a pyramid shape.

14. The heat exchanger as recited in claim 10, further comprising:
an inner housing comprising side walls in which the channel is arranged; and
an outer housing configured to surround the coolant channel,
wherein, the side walls of the inner housing serve as the separating wall.

15. The heat exchanger as recited in claim 14, wherein the outer housing comprises a coolant inlet and a coolant outlet.

16. The heat exchanger as recited in claim 15, wherein, downstream of the coolant inlet, the first zones and the second zones are arranged relative to each other so that a coolant flow is equally distributed on the separating wall.

17. The heat exchanger as recited in claim 16, wherein, downstream of the coolant inlet, a first zone is arranged so as to extend along a length of the separating wall, the first zone being adjoined, as seen in a width direction, by the second zone which also extends along the length of the separating wall.

18. The heat exchanger as recited in claim 17, wherein the first zone is followed by a section that extends along the further width of the separating wall, and in which, as seen in a longitudinal direction, larger second zones alternate with narrow first zones.
